(19) United States
(12) Patent Application Publication
(10) Pub. No.: US 2003/0094886 A1
(43) Pub. Date: May 22, 2003

(54) Bulb structure

(76) Inventor: Wun Fang Pan, Hsinchu (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 09/988,430

(22) Filed: Nov. 20, 2001

(51) Int. Cl. H01J 5/16

(52) U.S. Cl. 313/110

(57) ABSTRACT

This invention relates to a bulb structure, which includes a glass shell, a pair of conductive wires, and a tungsten filament between the wires in the shell. The characteristic of the invention is that the glass shell of the bulb has a top portion, which can be any structure of a convex lens to condense light as a lighting spot for increasing a lighting decorative effect of a light string.

### BACKGROUND OF TBE INVENTION

A conventional bulb includes a glass shell, a pair of conductive wires, and a tungsten filament. As the conductive wires are connected with a power source, the tungsten filament will be electrified to emit light. Since the prior known glass shell of the bulb is in a same thickness, the bulb emits the light normally without any specialty.

Accordingly, the primary object of the invention is to provide a bulb structure, which has its top portion to be a structure as a convex lens for a special decorative effect. Now the features and advantages of the invention will be described in detail with reference to the accompanying drawings.

### BRIEF DESCRIPTION OF THE INVENTION

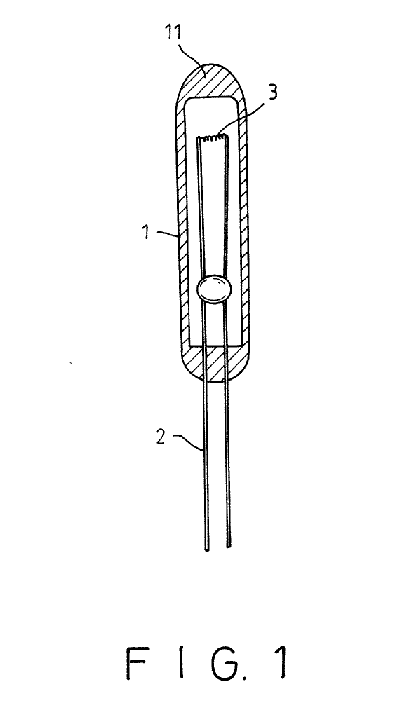

FIG. 1 is a cross-sectional plan view showing a bulb structure according to the invention.

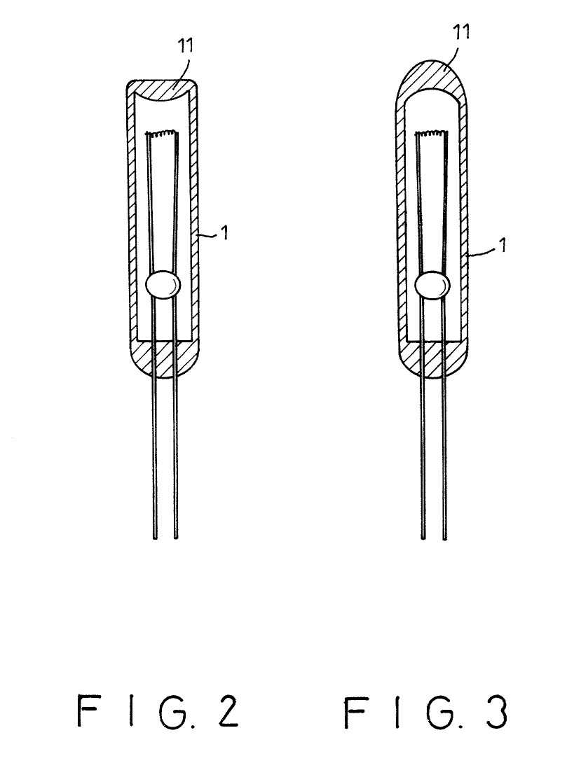

FIG. 2 is a cross-sectional plan view showing another embodiment of a bulb structure according to the invention.

FIG. 3 is a cross-sectional plan view showing a further embodiment of a bulb structure according to the invention.

### DETAILED DESCRIPTION OF THE INVENTION

Please first refer to FIG. 1, the present invention relates to an improvement of a bulb structure. The bulb includes a glass shell (1), a pair of conductive wires (2), and a tungsten filament (3) between two wires (2) in the shell (1) that is similar to a prior art one. The characteristic of the present invention is to provide the glass shell (1) having its top portion (11) to be a convex lens. So the thickness of the shell (1) is not all the same. In this embodiment of FIG. 1, the top portion (11) has an inner plan side and an outer convex side. When the bulb is lightened, the light penetrated through the top portion (11) will be condensed. It shows a strong lighting spot to a curtain position and obtains a shining decorative effect.

When a light string has been provided with all bulbs according to the present invention, people who walk around will see a better twinkle effect of the light string because of the condensed lighting spots.

The embodiment mentioned above is only an example according to the present invention. It is to be understood that the bulb structure can be modified under the same invented spirit, such as shown in FIGS. 2 and 3, each of which has a different shape of top portion sti 11 being a condensing lens. That will be claimed in this application too. Above all, the present invention obviously meets the requirements of granting a patent. We hereby file an application for a patent grant.

What is claimed is:

1. A bulb structure including a glass shell, a pair of conductive wires, and a tungsten filament between the wires in the shell, and the characteristic is that the shell has a top portion being a convex lens for condensing light as a lighting spot.
